(19) United States
(12) Patent Application Publication
(10) Pub. No.: US 2008/0241348 A1
(43) Pub. Date: Oct. 2, 2008

(54) Z-Trim mixed with water and erythritol or FOS

(76) Inventor: Keith Earl Kenyon, Sherman Oaks, CA (US)

Correspondence Address: KEITH E. KENYON, M.D., 4501 NAGLE AVENUE, SHERMAN OAKS, CA, 91423, US

(21) Appl. No.: 11/729,273

(22) Filed: Mar. 28, 2007

(51) Int. Cl. A23L 1/308

(52) U.S. Cl. 426/639

(57) ABSTRACT

This disclosure is about making low calorie food with the use of a zero calories, zero glycemic, cellulosic dietary fiber gel called Z-Trim which is ordinarily used as a powder by itself to reduce fat in cooking but has been used in this disclosure, when combined with zero calories erythritol or very low calories fructo-oligosaccharide (FOS), to be used with the Combination of Z-Trim and water. Thus one or the other serves to be used by itself or in the case of using them both serves to expand the use of reducing fat or eliminating flour and sugar or both, when used in cooking.

### CROSS REFERENCE TO RELATED APPLICATIONS

This is an effort to combine patent application Ser. No. 11/301,181, “Z-Trim Combined Directly with Erythritol”, Ser. No. 11/358,619, “Binding Virtually Zero Calories Saccharide-Type Bulk to Dietary Protein” Ser. No. 11/371,281, “Soy-Erythritol Compositions for Health”, Ser. No. 11/397,042, “Erythritol Suppression of Ghrelin”, Ser. No. 11/409,310 “Sweetening Erythritol by Permanent Magnet Means”, 11/586,749. “Enhancing Erythritol Ghrelin Suppression” and 11/648960 “Weight Management with sugars, hygroscopic insoluble substances and water”.

### STATEMENT REGARDING FEDERALLY SPONSORED RESEARCH/DEVELOPMENT

The present invention does not involve any form of federally sponsored research or development.

### BACKGROUND OF THE PRESENT INVENTION

The previous disclosures are mostly about the use of hygroscopic dietary substances usually called Z-Trim combined with non-hygroscopic erythritol, the combination of which is Z-Flour. This disclosure seeks to further clarify the issue by emphasizing that apart from its general use in baking and fat replacement, including cookies, the principle can be extended to inulin, especially fructo-oligosaccharide (FOS) for fat replacement and bread of any description. The use of Z-Flour as erythritol and erythritol only (because of its being virtually zero calories) has a use in weight management, can be marketed with its dry ingredients, the specific water requirement to be added by the consumer, and can be unmixed dry in shipping small amounts, the consumer adding water. It is also used as a fat replacer, however, this use with Z-Trim, erythritol and water is more useful as a pastry ingredient due to the increased sweetness of erythritol, but the lower sweetness of FOS is better when it comes to fat replacement. The other ingredients, including fat, can be added at the users' discretion and play no role in its primary claims or patentability.

The principal underlying basic patents on erythritol and FOS are in the public domain including its fermentation from glucose. On the other hand, a patent on the dietary cellulosic fiber gel Z-Trim is still in force. Z-Trim was invented by George Inglett, Ph.D. in 1998 and awarded U.S. Pat. No. 5,766,662, which is herein incorporated by reference in its entirety. Dr. Inglett's patent was assigned to the United States Department of Agriculture to be licensed appropriately. During this time erythritol was not marketed with Z-Trim and fat even though Z-Flour was of virtually zero calories and zero glycemia.

The USDA was interested in awarding licenses for the technology, and in 2002 or before Cargill, being a manufacturer of erythritol, attempted to use fat, Z-Trim and erythritol to make a confection of the two. It was hoping that the Z-Trim would minimize the inherent limitations in the use of erythritol in cooking, primarily erythritol's endothermic tendency. By Nov. 4, 2002, Cargill, Inc. and Cerestar Holding BV filed for patent protection in application number 20040086615. Today when one looks at patent application number 20040086615, one sees fructo-oligosaccharide (FOS) and not Z-Trim. This was not the case on Feb. 16, 2006, when a patent application about fat, Z-Trim and erythritol was downloaded and the two applications under the same number have a strange role in Cargill's and USPTO's behavior. The patent applications each were recorded under the same patent application number, 20040086615, yet FOS or fructo-oligosaccharide (the combination with erythritol that Cargill now prefers) has no commonality with Z-Trim yet Cargill infers that there is, although not according to routine USPTO protocol. The first two claims for the FOS application are printed as follows:

1. A confectionery composition comprising at least about 25 wt. % fat and at least about 5 wt. % of an erythritol/FOS combination; wherein the erythritol/FOS combination includes erythritol and an FOS component; and the FOS component includes at least about 25 wt. % fructo-pligosaccharide having a DP greater than 20 and at least about 50 wt. % fructo-oligosaccharide having a DP less than 20.

2. The composition of claim 1 wherein the erythritol/FOS combination has an erythritol/fructo-oliggosaccharide weight ratio of about 30:70 to about 70:30.

Contrast the claims of this patent application with those of the same patent application (20040086615) using Z-Trim.

1. A confectionery composition comprising at least about 25 wt. % fat and at least about 5 wt. % of an erythritol/Z-TRIM combination; wherein the erythritol/Z-TRIM combination includes erythritol and a Z-TRIM component.

2. The composition of claim 1 wherein the erythritol/Z-TRIM combination has an erythritol/Z-Trim weight ratio of about 30:70 to about 70:30.

As can be seen there is no contrast between the two entities in both claims 1 other than defining the FOS component and the Z-Trim component but why do it as a single application? This brings us to the extraordinary conclusion that Cargill wanted to include both patents under the same application and the USPTO in spite of the fact that it was an unusual request allowed it to be printed on USPTO forms with identical paperwork, except that information pertinent to Z-Trim was interchanged with that of FOS so that FOS and its factors could be substituted for Z-Trim. This FOS disclosure did not include incorporating Dr. Inglett's patent in the FOS disclosure as referenced material As can be deduced by this duality of patent applications, Cargill took the opportunity afforded them by Dr. Inglett of taking some of the Z-Trim and reacting it in a confection with 25% fat and erythritol primarily because it would cool down erythritol's negative heat of solution. This disclosure- being based on Dr. Inglett's patent, including fat, erythritol and Z-Trim in Cargill's context would presumably be patentable and still may be. They also tried FOS with the same fat and erythritol, which is not patentable and no patent was issued to them. Yet what would have been the patent picture of Cargill had they built on the patent of Dr. Inglett and filed it as a separate patent application?

However FOS won the battle at Cargill and is being marketed today, finding use in such confections as ChocoPerfection™ using chocolate, oligofructose (another name for FOS) and erythritol, while Z-Trim was presumably shelved by Cargill. During this time a company called Circle Group Holdings, Inc., now Z-Trim Holdings, Inc., obtained a license from the USDA and proceeded to start manufacturing Z-Trim, without erythritol being part of its marketing plan or even having erythritol incorporated in any way. Thus, Cargill was apparently abandoning patent activity involving the use of erythritol with dietary fiber gels, such as Z-Trim, and using that identical patent activity with FOS.

Where does this leave the patent activity regarding using zero calories erythritol with Z-Trim? In 2005 the present inventor started to put Z-Trim with erythritol only not make fat necessary to be incorporated as the third part of the confection or other foods. Patents were not sought to claim fat in claim 1. It is hard to believe that Cargill tried to confuse Z-Trim with FOS by going so far as to submit duplicate applications concerning both but now using only FOS. Cargill did not realize or indicate that FOS could be used with Z-Trim as a fat replacer. Instead they used a carbohydrate, FOS, combined with another carbohydrate erythritol to lower the perception of coolness, and they apparently did not believe Z-Trim filled this bill.

This invention is designed, among other things, to overcome the deficiencies of previous applications and inventions by employing new means to replace among other things, when appropriate, sugar, flour and fat in food and its recipes.

### BRIEF SUMMARY OF THE INVENTION

This disclosure teaches that the only thing Z-Trim has in common with the sugars erythritol and FOS is that they are originally from plant sources. That aside, FOS and erythritol are not derived by changing the texture of the end product, but Z-Trim is. FOS is a complex carbohydrate derived as a sugar and is half as sweet as sucrose, and erythritol is a polyol or sugar alcohol also derived as a sugar and is 70-80% as sweet as sucrose, while Z-Trim is formed from husks of grain and is non sweet and has no taste. FOS has about one calorie a gram so, therefore, would have slightly more calories than Z-Trim's zero. What is the need for Z-Trim that Cargill and the USPTO seem to confuse by intermingling the two patent applications, such being not ordinarily done by the USPTO? It's obvious that Cargill became uninterested in Z-Trim probably because they were manufactures of FOS. FOS and erythritol can be formed by fermentation together using the same process from sucrose by FOS' use of yeast. When mixed it would diminish erythritol's capacity to be endothermic. Of course both are manufactured by sophisticated means today. This was its reason for FOS to be used by Cargill but so would the combination of Z-Trim and erythritol, and this would bring much more to the table, but it would not require the mandatory use of fat in each confection as is the point of this disclosure.

Because FOS is sold as a sugar, can be fermented from sucrose and is water soluble, whereas Z-Trim is a cellulosic dietary fiber gel that is neither of sugar origin nor water soluble, why is FOS included with erythritol in Cargill's patent applications? They are not patentable. Erythritol or FOS needs for Z-Trim to be part of the mix and fat and protein are incidental parts of it and it promises no or low calories to be patentable. Why did Cargill not use Z-Trim in its disclosures? This is not answered by inclusion of patented Z-Trim in one then substituting it out in favor of another sugar in the same patent application. Furthermore, while the patent application, being of identical portions of the two ingredients, FOS and Z-Trim are given as interchangeable, from about 30:70 to 70:30, they are not interchangeable as such. While 30 units of Z-Trim would be possible, although too much as far as the consumer would want, 70 units is off the board. This would not be true with erythritol in the FOS patent. What they are enacted with, including fat, would fail when used with Z-Trim because there is too much Z-Trim in the mix of the application, but it will work well when used in a reduced amount as is disclosed here with FOS and erythritol because the two are both sugars.

This brings us to the heart of this disclosure, an extension of the patent applications of this inventor, wherein FOS is included wherever and as much as its lower threshold of sweetness will allow, but erythritol is also used when combined with Z-Trim in the form of Z-Flour. Whereas, Cargill was interested in the fact that FOS was sweet, it was not sweet enough to be used alone. Cargill added FOS to the mix presumably because it would mitigate erythritol's endothermic nature, but this was not the same as erythritol-Z-Trim (Z-Flour). Z-Trim is a cellulosic dietary fiber gel, not another sugar. Therefore, Cargill should have kept the Z-Trim formula so that erythritol was combined with a substance that would maintain its low calories but would add a hygroscopic, completely insoluble substance that would confer entirely different properties and could render the combination a fat replacer. Of course fat replacement was not the objective of patent number 20040086615 since it included fat as a primary constituent.

Since the patent of 20040086615 that is about erythritol and Z-Trim is not active as a patent right now and has apparently been withdrawn, we will regard it as belonging in the public domain but not the inclusion of erythritol and Z-Trim together with nothing else added but water in the first claims. Then this disclosure will be a combination of Z-Trim and erythritol with water in the replacement of fat in a recipe. This will ordinarily be the partial replacement of fat in the case of deep frying or pan frying but in the case of room temperature or frozen fats, the fats can be replaced in total if desired. This would include yogurts and ice cream to which FOS could replace erythritol if less sweetness without artificial sweeteners were tolerated.

In ordinary use the fat will be replaced partially to keep the overall taste as close to the original as possible. This would include butter, margarine, sour cream, salad dressings, mayonnaise, and the like, and here the relative lack of sweetness of FOS would be desirable.

We have two things that we bring to this disclosure, the Z-Trim-erythritol mix and the Z-Trim-FOS mix. They are similar but they have some differences. FOS and Z-Trim each bring fiber to the mix whereas the fiber is only confined to the Z-Trim in the Z-Trim-erythritol mixture. The other thing is the Z-Trim-FOS mix is to be used as a fat replacement primarily since it is substantially less sweet, while the Z-Trim-erythritol mix can be readily made into any kind of pastry without artificial sweeteners.

The fact that erythritol has an endothermic nature so is cool when put into mouth is inconsequential in this disclosure since it doesn't matter in room temperature applications and the coolness is lost in pastries, and the Z-Trim will diminish the activity. Since FOS has no endothermic nature, its replacement with erythritol has no bearing on the consequences unless it is to be combined with erythritol, but its combination with Z-Trim and water has no role in previous studies, there being no fat included.

Whereas, Z-Trim and erythritol, henceforth to be called Z-Flour, have uses when included with water, that include pastry and fat replacement, FOS can be substituted for erythritol by simply removing one for the other when fat replacement or bread-making are the goals, being it is less sweet. Thus we have dual compositions that can run the sweetness gambit from relative lack of sweetness in FOS to gradual increasing sweetness in mixtures of the two until the maximum sweetness of pure Z-Flour is reached. Therefore this disclosure teaches that it is possible to have the alternative of flour, sugar or both in a low calorie mixture of Z-Trim and FOS or erythritol.

In a mixture of the two, Z-Trim and sugar, before adding water, the mixture of Z-Trim holds the minimum position of being at 25% by wt. or less, the remainder being of either erythritol or FOS or both. Since Z-Trim is very a very light powder, it will occupy about half the volume by wt. of an erythritol-Z-Trim (Z-Flour) mixture when 20% by wt. Z-Trim.

The features of the present invention which are believed to be novel are set forth with particularity. The present invention, both as to its organization and the manner of operation, together with the further objects and advantages thereof, may be best understood by reference to the following exemplary and non-limiting detailed description of the invention, wherein;

### DETAILED DESCRIPTION OF THE PREFERRED EMBODIMENT NO DRAWINGS

This disclosure has two embodiments the use of which depends upon the desired sweetness of the product. We will start with FOS and Z-Trim and place the two in a package that does not need to be mixed if it is small enough to be used by the consumer and stored at the same time. This could be packaged in one pound amounts for example. If it is to be shipped in large quantities, pre-mixing at the source is required. Nevertheless, this requires approximately 20% by wt. Z-Trim and approximately 80% by wt. FOS. Once it arrives at the use point 80 to 100% by wt. water is added to bring it to 180 to 200% by wt. In absolute terms this would mean 1 part Z-Trim, 4 parts sugar and then the weight of both doubled by the addition of water or the amount slightly lowered in cases where more substance is required such as bread because of bread's use of water independently. Then depending on its use, after it is mixed with water, it is mixed with other ingredients. It may be that a user will want to mix the water in after the other ingredients are in, but this is an invention that requires Z-Trim, FOS and water regardless of which order they are mixed in.

The second embodiment has been dealt with in other of this inventor's disclosures but we will start with erythritol and Z-Trim and place the two in a package that does not need to be mixed if it is small enough to be used and stored by the consumer at the same time by being packaged in one pound amounts for example. If to be shipped in large quantities, pre-mixing at the source is required. Nevertheless, this requires 20% by wt. Z-Trim and 80% by wt. erythritol which we call Z-Flour. Once it arrives at the use point 80 to 100% by wt. water is added. In the case of cookies we would add water in the weight of the erythritol. In absolute terms this would mean 1 part Z-Trim, 4 parts sugar and then the weight of water either doubled the amount or slightly lowered in cases where more substance is required such as cookies. Then depending on its use, after it is mixed with water, it is mixed with other ingredients. It may be that a user will want to mix the water in after other ingredients are in, but this is an invention that requires Z-Trim, erythritol and water regardless of which order they are mixed in.

The embodiments can have the FOS and the erythritol mixed together in any amount as long as their totality doesn't exceed the amount of each sugar in embodiments 1 and 2.

It will not ordinarily be that Z-Trim will move toward the 25% by wt. amount, but will move in the other direction. In liquid or highly viscous solids like mayonnaise the mixture can have even more water than stated in the preferred embodiments.

Whereas the Z-Flour embodiment has uses in very low calorie pastry, the FOS-Z-Trim embodiment has uses in low calorie bread, especially if vinegar or less vinegar for sweetness control is desired. The beauty of using FOS in breads including pizza, tacos and tortillas, is that its low calories at one calorie a gram is almost as low as are Z-Trim and erythritol, yet it is far less sweet than erythritol. Conversely in pastry Z-Flour has the advantage, yet it is made by just substituting FOS for it.

Fat and protein including protein isolates and chocolates can be added to both embodiments after the fact of the original claims, as can any condiment or baking aid. For example shortening, eggs, vanilla extract, baking powder, baking soda, salt, nuts, yeast, etc. can be used as with any recipe.

While artificial sweeteners are not to be used in these disclosures, if someone were to want a food substance to be sweeter then possible with the disclosures, artificial sweeteners could then be added subject to the user's taste.

Erythritol, which has weight management properties of its own, which are separate from FOS and Z-Trim in the suppression of ghrelin, can be used by itself to suppress ghrelin without calories in which case it can be packaged separately. An example of this can be 4 oz. of erythritol placed in a clear liquid proof package, say 6 by 8 inches. Then a 20 oz. bottle of water, for example Rimrock's AquaX, is added. The reaction will be that the contents turn cold which is due to erythritol's negative or endothermic heat of solution. After the solution returns to room temperature, 1 or 2 tablespoons are taken by mouth several times a day to cause ghrelin suppression during its absorption in the small intestine, where it works by causing an increase in osmolarity.

Soy or whey isolated protein powder may be substituted for zero calories Z-Trim when it is desired to keep the substance as low in calories as possible, have water occupy as high amount as is possible of the substance, but have the protein powder occupy the same position as Z-Trim. In practice about one part soy or whey isolated protein is mixed with two parts erythritol or FOS, then have 3 parts water added. As with the preferred embodiments these embodiments and the water that goes with them, takes the place of full calorie sugar and flour.

Flour and/or common sugar, which is not part of this disclosure, can also be used when the user desires

Pets including dogs and cats may have food using parts of this disclosure prepared for them.

While particular variations of the present invention have been described, it will be obvious to those skilled in the art that changes and modifications may be made without departing from my invention in its broader aspects of combining various low calorie sugars with the hygroscopic cellulosic dietary fiber gel, Z-Trim.

I claim:

1. A composition comprising up to 25% by wt. of the cellulosic dietary fiber gel Z-Trim and at least 75% by wt. of fructo-oligosaccharide (FOS) with an amount of water added at least to 80% by wt. of the combined Z-Trim and fructo-oligosaccharide (FOS),

2. The invention of claim 1 wherein erythritol is substituted for fructo-oligosaccharide (FOS).

3. The invention of claim 1 wherein shortening, eggs, vanilla extract, baking powder, baking soda, salt, nuts or yeast may be added in cooking.

4. The invention of claim 2 wherein shortening, eggs, vanilla extract, baking powder, baking soda, salt, nuts or yeast may be added in cooking.

5. The invention according to claim 1 in which artificial sweeteners may be used.

6. The invention according to claim 2 in which artificial sweeteners may be used.

7. The invention in which erythritol by itself has ghrelin suppression activity.
